(19) United States
(12) Patent Application Publication
(10) Pub. No.: US 2006/0202069 A1
(43) Pub. Date: Sep. 14, 2006

(54) Odorless and microbe-resistant food waste disposer

(76) Inventor: Edward Chavez, Anaheim, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/075,190

(22) Filed: Mar. 8, 2005

(51) Int. Cl. B02C 23/36

(52) U.S. Cl. 241/30; 241/46.013

(57) ABSTRACT

A disposer is disclosed, having one or more parts made with anti-microbial properties in order to protect the disposer against odors and to resist the growth of microbial organisms within the disposer.

### FIELD OF THE INVENTION

1. Field

Embodiments relate to domestic appliances, and in particular, to disposers.

2. Related Art

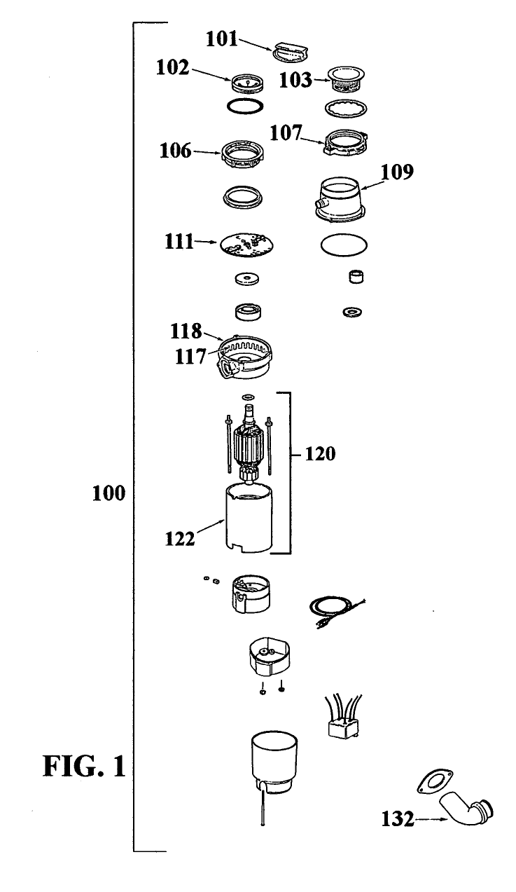

FIG. 1 is an assembly view of a typical disposer. In typical disposer 100, mostly-plastic or rubber parts are used in the areas of disposer 100 in which food products are processed, or through which water flows.

Food and water enter disposer 100 through sink-flange and cap assembly 103 and splash-guard 102. Sink flange and cap assembly 103 is capable of receiving stopper 101. Larger pieces of food (or other waste) are held in hopper 109 and drain housing 118. Waste is mixed with water, and broken into small particles by the action of turntable assembly 111 (turned by motor armature assembly 120) and its action against grind ring 117 of drain housing 118. Small particles of waste and water exit through an aperture in drain housing 118 connected to plumbing waste-line 132.

Because waste particles and water may remain in portions of disposer 100 after it is used, bacteria, fungus, or other microbial organisms accumulate and multiply in those parts of disposer 100. Such organisms cause unpleasant odors and/or potential health threats. Typical disposers have dangerous moving parts and are compact in order to fit into conventional sink areas. They are therefore difficult to clean, and are not made to be easily disassembled. Also, few consumers would wish to disassemble and clean a disposer on a regular basis.

While forming a disposer of stainless steel might make it easier to sterilize, such disposers would be more expensive and harder to produce than typical disposers with plastic and rubber parts. Cleaning a disposer with antibacterial soaps releases the antibacterial materials into the environment, which may be harmful, and may kill off helpful bacteria in septic tanks.

Sink strainers with antimicrobial properties are commercially available. However, they do not address the problem of bacteria or other organisms growing inside disposers.

Thus, what is required is a disposer with parts that discourage the growth of bacteria and other micro-organisms, while remaining affordable and easy to use and maintain.

### SUMMARY

Odor caused by food waste accumulated in the crevices within the interior of the food waste disposer is a major problem and complaint against disposers. The large amount of disposer cleaning and scrubbing products on the market addressing this problem is a testament to the consumer concern with disposer odors and cleanliness. Embodiments provide passive and constant protection against odor causing bacteria, as opposed to cleansing agents or additives that must be used or added frequently.

In some embodiments, a disposer is assembled with parts made from antimicrobial materials that protect against odor-causing bacteria.

In some embodiments, an antimicrobial hopper for a disposer is formed of a plastic, processed with an antimicrobial substance that protects against odor-causing bacteria. In some embodiments, the antimicrobial substance is Triclosan or AMK.

In some embodiments, an antimicrobial splash guard for a disposer is formed of a rubber-like material, processed with an antimicrobial substance that protects against odor-causing bacteria. In some embodiments, the antimicrobial substance is Triclosan or AMK.

In some embodiments, an antimicrobial sink flange and cap assembly for a garbage disposer is formed of a plastic, processed with an antimicrobial substance that protects against odor-causing bacteria. In some embodiments, the antimicrobial substance is Triclosan or AMK.

In some embodiments, an antimicrobial drain housing for a disposer is formed of a plastic processed with an antimicrobial substance that protects against odor-causing bacteria. In some embodiments, the antimicrobial substance is Triclosan or AMK.

In some embodiments, a disposer is constructed with some or all of the splash-guard, sink-flange, hopper; and drain housing processed with an antimicrobial substance that protects against odor-causing bacteria. In some embodiments, the grind ring and turntable are formed of stainless steel, which also prevents odor.

In some embodiments, a process for controlling odor and microbe growth in disposer-includes processing the material for those parts with an antimicrobial substance that protects against odor-causing bacteria. In some embodiments, the substance is used to treat only the inner surfaces of parts, which are exposed to water and waste.

### BRIEF DESCRIPTION OF THE ILLUSTRATIONS

FIG. 1 is an assembly view of a typical disposer.

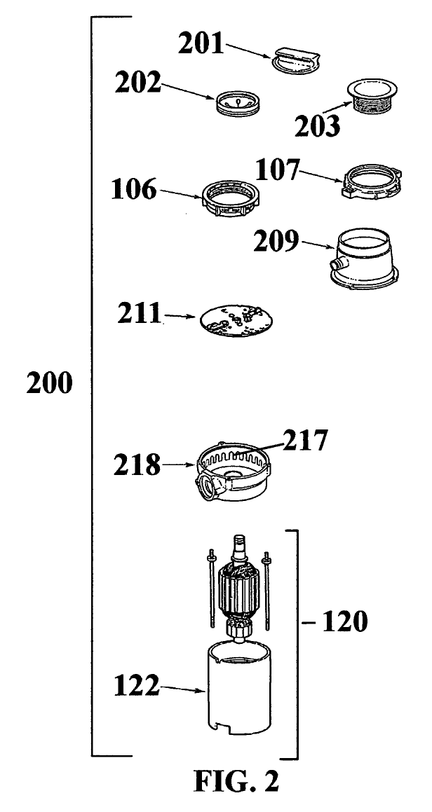

FIG. 2 is an assembly view of an embodiment of a disposer with antimicrobial components, according to the present invention.

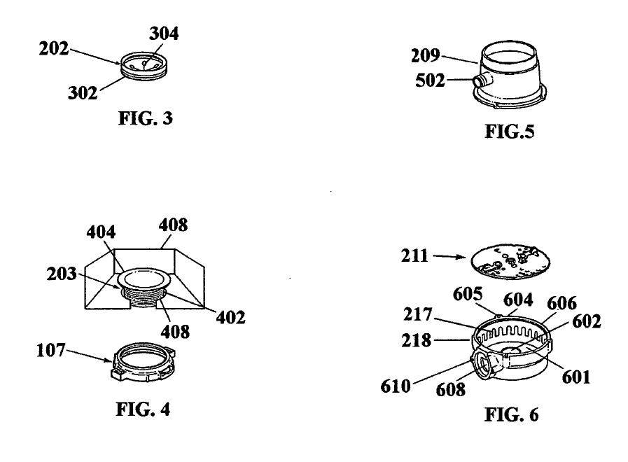

FIG. 3 is an illustration of an embodiment of an antimicrobial splash guard, according to the present invention.

FIG. 4 is an illustration of an embodiment of an antimicrobial sink-flange and cap assembly, according to the present invention.

FIG. 5 is an illustration of an embodiment of an antimicrobial hopper, according to the present invention.

FIG. 6 is an illustration of an embodiment of an antimicrobial drain housing, according to the present invention.

### DESCRIPTION

FIG. 2 is an assembly view of an embodiment of a disposer with antimicrobial components, according to the present invention. Parts which are similar to those of typical disposer 100, as shown in FIG. 1, are repeated with the same numbering.

In some embodiments, components of microbe resistant disposer 200 are functionally similar to components of typical disposer 100. However, parts where water and waste particles may linger, allowing bacteria or other microbial organisms to grow, are cast from antimicrobial plastic or rubber, which may be ordinary plastic or rubber treated with one or more antimicrobial agents. In some embodiments, those parts treated with an anti-microbial agent (or formed from an anti-microbial material) are stopper 201, splash guard 202, sink flange and cap assembly 203, hopper 209, and drain assembly 218.

In some embodiments components are treated with Triclosan or AMK. Triclosan is manufactured and distributed by Shanghai Huaway Chemical Co., Ltd of Shanghai, China. Triclosan is mixed at a ratio of approximately 0.4% with the base plastic or rubber.

AMK (amikacin) is manufactured and distributed by Fuzhou Fuxing Pharmaceutical Co., Ltd. of Fuzhou, China. In some embodiments, AMK is mixed in a proportion of approximately 1% with the base plastic or rubber.

In some embodiments, stopper 201, splash guard 202, sink flange and cap assembly 203, hopper 209, and/or drain assembly 218 are made to be replacements for their equivalents in typical disposer 100. In some embodiments, stopper 201, splash guard 202, sink flange and cap assembly 203, hopper 209, and/or drain assembly 218 are made to fit into other parts of typical disposer 100. For example, sink flange and cap assembly 203 is made to fit cap 100 and to fit into mount ring 107, and drain housing 218 is made to accommodate a standard grind ring 117.

In some embodiments, grind ring 217 is formed from a stainless steel (which is itself microbe-resistant), for example Series 300, or another suitably hard material, having antimicrobial properties.

FIG. 3 is an illustration of an embodiment of an antimicrobial splash guard, according to the present invention. In some embodiments, splash guard 202 is similar to typical splash guard 102 in size, shape, and material properties. Splash guard 202 is an elastic rubber disk, with flange 302 around it, so it can be secured in sink flange and cap assembly 203. Slots 304, cut in the disk portion of splash guard 202 allow waste (e.g., food) to be pushed through splash guard 202 into hopper 209. Because splash guard 202 is formed of an elastic material (rubber), it returns to its flat shape, thus preventing water and waste from being splashed upward.

In some embodiments splash guard 202 is formed of a material with anti-microbial properties that protects against odor-causing bacteria. In some embodiments, splash guard 202 is a rubber-like material, treated with an antimicrobial agent, such as Triclosan or AMK.

FIG. 4 is an illustration of an embodiment of an antimicrobial sink-flange and cap assembly, according to the present invention. In some embodiments, sink-flange and cap assembly 203 is similar to typical assembly 103 in size, shape, and material properties. Sink flange 203 is a cylindrical, hollow tube with outside threads 402, which attach it to mount 107. Water and waste flow through sink flange and cap assembly 203 to hopper 209. Flange 404 holds sink flange and cap assembly 203 against hole 406 cut in the bottom of typical kitchen sink 408.

In some embodiments, sink-flange and cap assembly 203 is formed of a material with anti-microbial properties. In some embodiments, sink-flange and cap assembly 203 is a plastic or plastic-like material, treated with an antimicrobial agent that protects against odor-causing bacteria. In some embodiments, substantial treatment with the antimicrobial agent is performed specifically on the top flange and inner surfaces of sink-flange and cap assembly 203, because those surfaces encounter water and waste. Production costs are lowered by treating only a portion of the surfaces of sink-flange and cap assembly 203.

FIG. 5 is an illustration of an embodiment of an antimicrobial hopper, according to the present invention. In some embodiments, hopper 209 is similar to typical hopper 109 in size, shape, and material properties. Hopper 209 is a cylindrical tube, through which water and waste collect, and flow into drain assembly 218. In some embodiments, Hopper 209 is made with dishwasher connection 502, through which waste from a dishwasher is channeled through disposer 200. Hopper 209 is also provided with mating flange 504 for connection to drain housing 218.

In some embodiments hopper 209 is formed of a material with anti-microbial properties that protects against odor-causing bacteria. In some embodiments, hopper 209 is formed of a plastic or plastic-like material, treated with an antimicrobial agent of the type that protects against odor-causing bacteria. In some embodiments, substantial treatment with the antimicrobial agent is performed specifically on the inner surfaces of hopper 209, because those surfaces encounter water and waste. Production costs are lowered by treating only a portion of the surfaces. It may be desirable to also treat surface which mate with other components as waste particles can become trapped in gaps in the interfaces.

FIG. 6 is an illustration of an embodiment of anti-microbial drain housing, according to the present invention. In some embodiments, drain housing 218 is similar to typical drain housing 118 in size, shape, and material properties.

Drain assembly 218 is a cylindrical container, with closed base 601, having access-hole 602 for a shaft from motor 120 to connect to turntable 111. The upper portion of drain assembly 218 is provided with flange 604 for forming a seal against hopper 209. In some embodiments, threaded holes 605 are provided for attachment with screws.

Referring to FIGS. 1 and 2, waste is mixed with water, and broken into small particles by the action of turntable assembly 211 (turned by motor armature assembly 120) and its action against grind ring 217, located in area 606 of drain housing 218. Small particles of waste and water exit through aperture 608 in drain housing 218 connected to waste-line 132 by plumbing connection 610.

In some embodiments drain housing 218 is formed of a material with anti-microbial properties that protects against odor-causing bacteria. In some embodiments, drain housing 218 is formed of a plastic or plastic-like material, treated with an antimicrobial agent that protects against odor-causing bacteria. In some embodiments, only those surfaces likely to contact water and waste are treated with the agent, for example the upper surface of base 601, area 606 surrounding grind ring 217, and around aperture 608.

In some embodiments, turntable 211 is formed from a stainless steel (which itself has intrinsic microbe-resistant properties), for example Series 300, or from another suitably hard, antimicrobial material.

Some antimicrobial agents that protect against odor-causing bacteria have different melting points than some plastics. In some embodiments, an antimicrobial agent is formed into pellets which will melt at the same temperature as the originating material of the part being formed to assure strength of the material.

In some embodiments, an antimicrobial agent is formed into pellets which will melt against mostly one surface of the part being formed. Allowing only part of the plastic to be treated saves on the amount of agent required, and therefore on the cost of producing disposer 200.

In some embodiments, antimicrobial protection is provided on all disposers parts that come into contact with the food waste and that are not made of stainless steel, which provides its own antimicrobial protection. In some embodiments, forming stopper 201, cap assembly 202, hopper 209, drain housing 218, and splash guard 203 of antimicrobial-treated (or intrinsically antimicrobial) plastic or rubber, and turntable 111 and grind ring 217 of stainless steel, provides anti-microbial protection on all the surfaces likely to retain water and waste.

Many plastic and plastic-like materials are available for forming appliance parts. The term “plastic” is used broadly, to refer to the wide variety of materials which are or have properties similar to plastics (and are not intended as limited to particular technical definitions). Some plastics that are used in disposers are PVC, polypropylene, ABS, nitrile, NBR, BUNA, and polycarbonate. These common plastics are available from numerous chemical supply manufacturers and distributors. Many such substances known to the art, or which may become known to the art, lend themselves to being formed into disposer parts and treated with antimicrobial agents that protect against odor-causing bacteria.

Many flexible, water-proof substances are known to the art. The terms “rubber,” or, “rubber-like”, are used broadly, to denote any such materials, and are not intended to limit the choice of materials to a technical definition (e.g., sap from a rubber tree). Some “rubber or “rubber-like” materials used in disposers are nitrile, NBR, and BUNA. These common materials are available from numerous chemical supply manufacturers and distributors.

There are many substances which retard the growth of odor causing bacteria, fungus, mold, and other undesirable micro-organisms. The term “anti-microbial” is to be interpreted broadly, inclusive of substances retarding the growth of mold, fungus, bacteria, viruses, and/or other micro-organisms.

Thus, a disposer is provided, which is protected against odors and resistant to the growth of microbial organisms, and which can be constructed with most of the parts of a typical disposer. Such disposers also improve home sanitation, while remaining affordable, and reduce the amount of cleaning agents released into the environment.

While various embodiments of the invention have been described, it should be understood that they have been presented by way of example and not limitation. Those skilled in the art will understand that various changes in forms or details may be made without departing from the spirit of the invention. Thus, the above description does not limit the breadth and scope of the invention as set forth in the following claims.

I claim:

1. A hopper for a disposer, comprising:
A conical shell, comprising:
an upper edge, capable of being attached to a mounting ring; and
a lower flange, capable of being attached to a drain housing;
formed of a plastic, wherein the plastic comprises an antimicrobial substance.

2. The hopper of claim 1, wherein the substance is one of Triclosan or Atim-AMK.

3. A splash guard for a disposer, comprising:
a disk surface comprising radial slots; and
a flange;
formed of a flexible material,
wherein, the flexible material comprises an antimicrobial substance.

4. The splash guard of claim 3, wherein the antimicrobial substance is one of Triclosan or AMK.

5. A sink flange and cap assembly for a disposer, comprising:
A cylindrical portion, having an outer surface, the outer surface comprising a threaded portion; and,
A flange portion capable of being attached to a sink drain;
Wherein, a portion of the assembly is formed of a plastic comprising an antimicrobial substance.

6. The sink flange of claim 5, wherein the antimicrobial substance is one of Triclosan or AMK.

7. A drain housing for a disposer, comprising:
A hollow cylindrical portion, comprising a top end, capable of being attached to a hopper;
A flat base;
An exit port, capable of attachment to a waste line; and,
An inner surface area, capable of receiving a grind ring;
formed of a plastic material, wherein the plastic material comprises an antimicrobial substance.

8. The drain housing of claim 7, wherein the antimicrobial substance is one of Triclosan or AMK.

9. A disposer, comprising:
a splash guard;
a sink flange;
a hopper; and,
a drain housing;
wherein, one or more of the splash guard, sink flange, hopper, and/or drain housing comprise an antimicrobial material.

10. The disposer of claim 9, wherein the antimicrobial material comprises plastic or rubber treated with an antimicrobial agent.

11. The disposer of claim 10, wherein the antimicrobial agent is Triclossan, and wherein the splash guard, sink flange, hopper, and drain housing are formed of plastic or rubber, and wherein the Triclosan is mixed in a proportion of between 0.3 and 0.5% to the plastic or rubber.

12. The disposer of claim 10, wherein the antimicrobial agent is AMK, and wherein the splash guard, sink flange, hopper, and drain housing are formed of plastic or rubber, and wherein the AMK is mixed in a proportion of between 0.9 and 1.1% to the plastic or rubber.

13. The disposer of claim 10, further comprising a grind ring and a turntable, and wherein the grind ring and turntable are formed of stainless steel.

14. The disposer of claim 9, wherein the sink flange, hopper, and drain housing each comprise a plurality of surfaces, and
wherein the sink flange, hopper, and drain housing are substantially formed of a plastic like material, and
wherein only that portion of the plurality of surfaces, likely to contact water or waste when in use, are treated with the antimicrobial substance.

15. A method for reducing microbial growth in a disposer, wherein the disposer comprises a plurality of components, comprising:
treating a portion of a material with an antimicrobial substance; and
forming a portion of the components of the disposer from the material.

16. The method of claim 15, wherein the portion of components comprises:
a sink flange and cap assembly;
a hopper; and,
a drain housing.

17. The method of claim 16, wherein the anti-microbial substance comprises Triclosan or AMK

18. The method of claim 16, wherein the portion of components each comprise a plurality of surfaces, and wherein the portion of material treated with the antimicrobial substance comprises those surfaces likely to contact water or waste when in use.

19. The method of claim 16, wherein the plurality of components each comprise inner and outer surfaces, and wherein the portion of material treated with the antimicrobial substance comprises the inner surfaces of the components.

20. The method of claim 19, wherein the material is plastic or rubber.

21. The method of claim 20, wherein the disposer further comprises a splash guard comprising an antimicrobial substance.

22. An odorless disposer, wherein the disposer is formed of components, made by the process of:
melting plastic or rubber together with pellets of an antimicrobial agent; and,
molding the one or more components from the plastic or rubber.

23. The disposer of claim 22, wherein the antimicrobial agent is Triclosan, mixed in a proportion of between 0.3% and 0.5% to the plastic or rubber.

24. The disposer of claim 22, wherein the antimicrobial agent is AMK, mixed in a proportion of between 0.9% and 1.1% with the plastic or rubber.
